(19) United States
(12) Patent Application Publication
(10) Pub. No.: US 2021/0390796 A1
(43) Pub. Date: Dec. 16, 2021

(54) METHOD, APPARATUS AND MOBILE TERMINAL FOR DISPLAYING DISTRIBUTION AND STATUSES OF ECU SYSTEMS OF VEHICLE

(71) Applicant: AUTEL INTELLIGENT TECHNOLOGY CORP., LTD., Shenzhen (CN)

(72) Inventors: Longhui ZHONG, Shenzhen (CN); Pingliang Chen, Shenzhen (CN)

(21) Appl. No.: 17/446,553

(22) Filed: Aug. 31, 2021

Related U.S. Application Data
(63) Continuation of application No. PCT/CN2020/080410, filed on Mar. 20, 2020.

(30) Foreign Application Priority Data
Mar. 20, 2019 (CN) 201910214381.6

(51) Int. Cl. G07C 5/00; G06F 3/14; G07C 5/08; G06F 16/248; G05B 23/02

(52) U.S. Cl. CPC G07C 5/008; G06F 3/14; G07C 5/0808; H04L 67/12; G06F 16/248; G05B 23/0221; G07C 5/0825

(57) ABSTRACT

A method, apparatus and mobile terminal for displaying a distribution and statuses of electronic control unit (ECU) systems of a vehicle are provided. An ECU topological diagram corresponding to vehicle information of a target vehicle is acquired and displayed on the mobile terminal. The ECU topological diagram includes at least two label elements and a topological relationship among the at least two label elements. Each of the at least two label elements identifies an ECU system matching the vehicle information, and the topological relationship includes a connection relationship among the ECU systems. The method acquires status information of the ECU system matching the vehicle information in the target vehicle, and sets a display status attribute of the label element used for identifying the ECU system. The technical solutions help maintenance and repair technicians reduce a range of inspection and improve working efficiency.

### CROSS-REFERENCE OF RELATED APPLICATIONS

This application is a continuation application of International Application No. PCT/CN2020/080410, filed on Mar. 20, 2020, which claims priority of Chinese Patent Application No. 201910214381.6, filed on Mar. 20, 2019, which is incorporated herein by reference in its entirety.

### TECHNICAL FILED

The disclosure relates to the technical field of vehicle diagnosis, more particularly to a method, apparatus and mobile terminal for displaying a distribution and statuses of ECU systems of a vehicle.

### BACKGROUND OF THE DISCLOSURE

In recent years, with continuous development of vehicle technologies, increasing electronic control unit (ECU) systems of increasing types exist in vehicles and increasingly close relationships exist among the ECU systems. Therefore, when one of the ECU systems fails, other ECU systems associated with the ECU system may also fail under influence of the ECU system.

However, currently, during vehicle diagnosis, most traditional barcode readers provide only reference information about whether each ECU system fails and/or a corresponding fault code. Maintenance and repair technicians need to check all faulty ECU systems one by one to comprehensively determine a cause of a fault of a vehicle. The diagnosis process is time-consuming, laborious and inefficient.

### SUMMARY OF THE DISCLOSURE

In view of these problems, the disclosure provides a method, apparatus and mobile terminal for displaying a distribution and statuses of ECU systems of a vehicle, which can resolve a problem that current vehicle diagnosis is time-consuming, laborious and inefficient.

To resolve the foregoing technical problems, the disclosure provides the following technical solutions.

A first aspect of the disclosure provides a method for displaying a distribution and statuses of ECU systems of a vehicle. The method is applicable to a mobile terminal. The method includes: acquiring and displaying an ECU topological diagram corresponding to vehicle information of a target vehicle, the ECU topological diagram including at least two label elements and a topological relationship among the at least two label elements, each of the at least two label elements being used for identifying an ECU system matching the vehicle information, and the topological relationship including a connection relationship among the ECU systems; acquiring status information of the ECU system matching the vehicle information in the target vehicle; and setting, according to the acquired status information of the ECU system in the target vehicle, a display status attribute of the label element used for identifying the ECU system.

In some instances, the acquiring status information of the ECU system matching the vehicle information in the target vehicle includes: receiving a selected scan instruction for the ECU topological diagram, the selected scan instruction being used for selecting a label element in the ECU topological diagram and indicating a scan for the ECU system identified by the selected label element; and acquiring, according to the selected scan instruction, the status information of the ECU system identified by the selected label element in the target vehicle.

In some instances, the acquiring status information of the ECU system matching the vehicle information in the target vehicle includes: receiving an automatic scan instruction for the ECU topological diagram, the automatic scan instruction being used for indicating a scan for the ECU system identified by each of the label elements in the ECU topological diagram; and acquiring, according to the automatic scan instruction, the status information of the ECU system identified by each of the label elements in the target vehicle.

In some instances, the method further includes: determining and displaying a scan progress of the ECU system during the acquiring status information of the ECU system matching the vehicle information in the target vehicle.

In some instances, the connection relationship among the ECU systems includes a bus type of a connection bus among the ECU systems.

In some instances, after the step of setting, according to the acquired status information of the ECU system in the target vehicle, the display status attribute of the label element used for identifying the ECU system, the method further includes: receive a query instruction for a first label element in the ECU topological diagram; and displaying, according to the query instruction, detailed status information of an ECU system identified by the first label element in the target vehicle.

A second aspect of the disclosure provides an apparatus for displaying a distribution and statuses of ECU systems of a vehicle running in a mobile terminal. The apparatus includes: a loading unit, configured to acquire and display an ECU topological diagram corresponding to vehicle information of a target vehicle, the ECU topological diagram including at least two label elements and a topological relationship among the at least two label elements, each of the at least two label elements being used for identifying an ECU system matching the vehicle information, and the topological relationship including a connection relationship among the ECU systems; a status information acquisition unit, configured to acquire status information of the ECU system matching the vehicle information in the target vehicle; and a first rendering unit, configured to set, according to the acquired status information of the ECU system in the target vehicle, a display status attribute of the label element used for identifying the ECU system.

In some instances, the status information acquisition unit is specifically configured to: receive a selected scan instruction for the ECU topological diagram, the selected scan instruction being used for selecting a label element in the ECU topological diagram and indicating a scan for the ECU system identified by the selected label element; and acquire, according to the selected scan instruction, the status information of the ECU system identified by the selected label element in the target vehicle.

In some instances, the status information acquisition unit is specifically configured to: receive an automatic scan instruction for the ECU topological diagram, the automatic scan instruction being used for indicating a scan for the ECU system identified by each of the label elements in the ECU topological diagram; and acquire, according to the automatic scan instruction, the status information of the ECU system identified by each of the label elements in the target vehicle.

In some instances, the apparatus further includes: a second rendering unit, configured to determine and display a scan progress of the ECU system during the acquiring of the status information of the ECU system matching the vehicle information in the target vehicle.

In some instances, the connection relationship among the ECU systems includes a bus type of a connection bus among the ECU systems.

In some instances, the apparatus further includes a query unit specifically configured to: receive a query instruction for a first label element in the ECU topological diagram; and display, according to the query instruction, detailed status information of an ECU system identified by the first label element in the target vehicle.

A third aspect, the disclosure provides a mobile terminal. The mobile terminal includes at least one processor; and a memory communicatively connected to the at least one processor, where the memory storing instructions executable by the at least one processor, the instructions being executed by the at least one processor, to enable the at least one processor to perform the method for displaying a distribution and statuses of ECU systems of a vehicle described above.

A fourth aspect, the disclosure provides a non-transitory computer-readable storage medium, the non-transitory computer-readable storage medium storing computer executable instructions, and the computer executable instructions being configured to enable the mobile terminal to perform the method for displaying a distribution and statuses of ECU systems of a vehicle described above.

A fifth aspect the disclosure provides a computer program product including a computer program stored in a non-transitory computer readable storage medium, the computer program including program instructions, the program instructions, when executed by a mobile terminal, causing the mobile terminal to perform the foregoing method for displaying a distribution and statuses of ECU systems of a vehicle.

The disclosures of the present disclosure have the following beneficial advantages: Different from the prior art, according to the method, apparatus and mobile terminal for displaying a distribution and statuses of ECU systems of a vehicle provided in the embodiments of the disclosure, the ECU topological diagram corresponding to the vehicle information of the target vehicle is first acquired and displayed. The ECU topological diagram includes at least two label elements and a topological relationship among the at least two label elements. Each of the at least two label elements is used for identifying an ECU system matching the vehicle information and the topological relationship includes a connection relationship among the ECU systems. Then the status information of the ECU system matching the vehicle information in the target vehicle is acquired. Finally the display status attribute of the label element used for identifying the ECU system is set according to the acquired status information of the ECU system in the target vehicle. In this way, a distribution and operating statuses of and a relationship among ECU systems in the target vehicle can be directly presented in real time. Maintenance and repair technicians can determine a source of a current fault based on faulty ECU systems and a distribution of and a connection relationship among the faulty ECU systems and formulate maintenance and inspection orders. Therefore, the range of inspection is reduced and the working efficiency is improved.

### BRIEF DESCRIPTION OF THE DRAWINGS

Technical solutions of embodiments of the disclosure will be described with reference the accompanying drawings. It will be apparent to those skilled in the art that, the drawings merely illustrate some embodiments of the disclosure, and other drawings can be conceived without any inventive effort.

FIG. 1 is a schematic structural diagram of a vehicle diagnosis system according to an embodiment of the disclosure.

FIG. 2 is a schematic diagram of interaction among devices in a vehicle diagnosis system shown in FIG. 1.

FIG. 3 is a schematic flowchart of a method for displaying a distribution and statuses of ECU systems of a vehicle according to an embodiment of the present disclosure.

FIG. 4 is an exemplary diagram of an ECU topological diagram according to an embodiment of the present disclosure.

FIG. 5 is an exemplary diagram of setting, in the ECU topological diagram shown in FIG. 4 according to acquired status information of an ECU system in a target vehicle, a display status attribute of a label element used for identifying the ECU system.

FIG. 6 is a schematic structural diagram of an apparatus for displaying a distribution and statuses of ECU systems of a vehicle according to an embodiment of the present disclosure.

FIG. 7 is a schematic structural diagram of a mobile terminal hardware according to an embodiment of the present disclosure.

### DETAILED DESCRIPTION OF THE DISCLOSURE

A better understanding of the disclosure will be obtained by reference to the following detailed description that sets forth illustrative embodiments with reference to the drawings. It should be understood that the embodiments herein are provided for describing the disclosure and not intended to limit the disclosure.

It should be noted that, if no conflict occurs, features in the embodiments of the disclosure may be combined with each other and fall within the protection scope of the present application. In addition, although functional module division is performed in the schematic diagram of the apparatus, and a logical sequence is shown in the flowchart, in some cases, the shown or described steps may be performed by using module division different from the module division in the apparatus, or in a sequence different from the sequence in the flowchart.

The embodiments of the disclosure provide a method, apparatus and mobile terminal for displaying a distribution and statuses of ECU systems of a vehicle.

The method for displaying a distribution and statuses of ECU systems of a vehicle may be performed by any mobile terminal, and directly displays a distribution and current operating statuses of and a connection relationship among ECU systems in a vehicle by using an ECU topological diagram. The method can help maintenance and repair technicians determine a source of a current fault based on faulty ECU systems and a distribution of and a connection relationship among the faulty ECU systems and formulate proper maintenance and inspection orders, thereby reducing the range of inspection and improving working efficiency.

In the embodiments of the disclosure, the apparatus for displaying a distribution and statuses of ECU systems of a vehicle is a virtual apparatus composed of software programs that can implement the method for displaying a distribution and statuses of ECU systems of a vehicle. The apparatus is based on the same inventive idea and has the same technical features and beneficial effects as the method for displaying a distribution and statuses of ECU systems of the vehicle.

The mobile terminal may be of any type, has a specific logic operation capability and provides one or more electronic devices that can satisfy users' intention. For example, the mobile terminal may include, but is not limited to, a diagnosis instrument having a display screen, a tablet computer, a smart phone, a notebook computer, and the like.

The embodiments of the disclosure are further described below with reference to the accompanying drawings.

### Embodiment 1

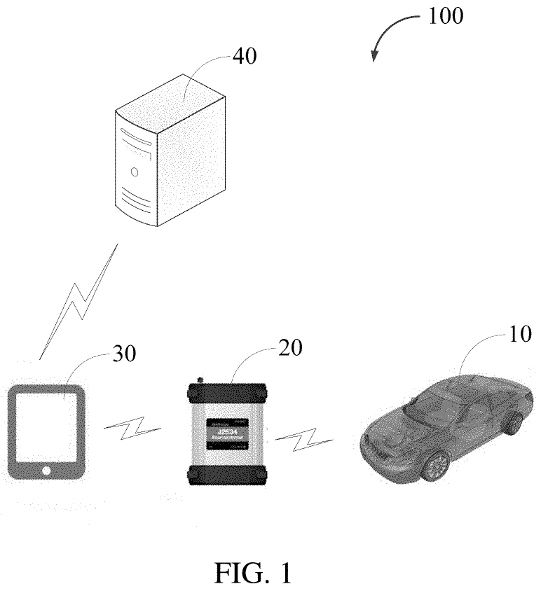

FIG. 1 is a schematic structural diagram of a vehicle diagnosis system according to an embodiment of the disclosure. The vehicle diagnosis system 100 may be used as one of the application environments of the method for displaying a distribution and statuses of ECU systems of a vehicle.

Specifically, referring to FIG. 1, a vehicle diagnosis system 100 includes a target vehicle 10, a communication device 20, a mobile terminal 30 and a cloud server 40.

The communication device 20 is communicatively connected to the target vehicle 10 and the mobile terminal 30. The mobile terminal 30 may transmit instructions/data to the target vehicle 10 and/or receive parameters/data returned by the target vehicle 10, by using the communication device 20, so as to achieve diagnosis for the target vehicle 10.

The mobile terminal 30 is communicatively connected to the cloud server 40 and may extract diagnosis files related to or matching the target vehicle 10 from the cloud server 40.

Specifically, the target vehicle 10 means a to-be-diagnosed vehicle, which may be any type of transportation means. In the embodiments of the disclosure, an automobile is exemplified for description. A plurality of electronic control unit (ECU) systems associated with each other are configured in the target vehicle 10. The plurality of ECU systems are core elements of the target vehicle 10 and are configured to manage and perform a plurality of functions of the target vehicle 10. The plurality of ECU systems may further exchange information and communicate by using a specific communication network (for example, a multiplexed communication network). Therefore, when one of the ECU systems fails, other ECU systems connected thereto may also fail accordingly.

The communication device 20 may be any type of communication box (or referred to as a lower computer). For example, the communication device 20 may be, but is not limited to, a vehicle communication interface (VCI) or an on-board diagnostic (OBD), which is configured to perform protocol conversion to build a communication link between the vehicle target vehicle 10 and the mobile terminal 30. It should be understood that, in practical application, if the mobile terminal 30 can directly communicate with the target vehicle 10, the communication device 20 may also be omitted, which is not specifically limited in the embodiments of the disclosure.

The mobile terminal 30 may be any type of electronic device having data processing and analysis capabilities, which may include but is not limited to, for example, a tablet computer, a smart phone, a notebook computer, and the like. Related diagnosis software may be installed in the mobile terminal 30. In this way, during vehicle diagnosis, maintenance and repair technicians can acquire diagnosis data/diagnosis results of the ECU systems of the target vehicle 10 based on the diagnosis software. The mobile terminal 30 is equipped with any type of display screen for displaying the diagnosis process and the diagnosis results of the target vehicle 10.

The cloud server 40 may be a data processing and storage center, which may pre-generate and pre-store diagnosis files corresponding to various vehicle types. The diagnosis file means a file used for assisting in vehicle diagnosis. For example, in the embodiments of the disclosure, the diagnosis file may be specifically an ECU topological diagram. The ECU topological diagram may include at least two label elements and a topological relationship among the at least two label elements. Each of the at least two label elements is used for identifying an ECU system. The topological relationship, includes a connection relationship among at least two ECU systems identified by the at least two label elements. In other words, the ECU topological diagram is used for presenting a distribution of and a connection relationship among ECU systems in a vehicle of a specific type.

The cloud server 40 may first classify vehicles of various types according to vehicle information, and then determine types and a quantity of ECU systems and relationship data about the ECU systems in a vehicle corresponding to vehicle information of each type, so as to draw an ECU topological diagram corresponding to the vehicle information of each type. The “vehicle information” may include, but is not limited to, a vehicle brand (for example, BMW), a model (for example, BMW X6), a model year (for example, 2018), an engine type, a gearbox model, and the like. The “relationship data” means a distribution of and a connection among ECU systems, such as a connection relationship among the ECU systems, a bus type of a connection bus among the ECU systems, relative distribution positions of the ECU systems, and the like. For example, for vehicle information of “BMW X6, 2018”, ECU systems are included in “BMW X6, 2018”, and relationship data about the ECU systems may be queried first. Then an ECU topological diagram corresponding to “BMW X6, 2018” is drawn based on the queried ECU systems and relationship data.

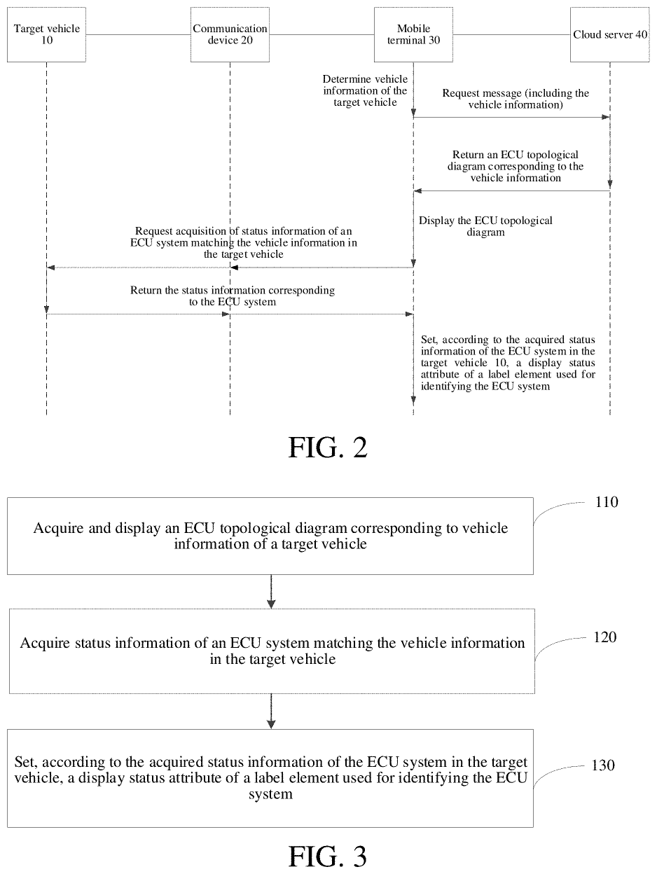

Therefore, during vehicle diagnosis for the target vehicle 10, as shown in FIG. 2, the mobile terminal 30 may determine vehicle information of the target vehicle 10, and then transmit a request message to the cloud server 40. The request message includes the vehicle information of the target vehicle 10. The cloud server 40 returns, according to the request message, an ECU topological diagram corresponding to the vehicle information to the mobile terminal 30. The mobile terminal 30 displays the ECU topological diagram on the display screen thereof after receiving the ECU topological diagram. Then the mobile terminal 30 may request, by using the communication device 20, the target vehicle 10 to acquire status information of an ECU system matching the vehicle information in the target vehicle 10. The target vehicle 10 reads the status information of the corresponding ECU system therein and returns the status information to the mobile terminal 30. The mobile terminal 30 sets, according to the acquired status information of the ECU system in the target vehicle 10, a display status attribute of the label element used for identifying the ECU system. In this way, the maintenance and repair technicians can directly learn a distribution and current operating statuses of and a relationship among the ECU systems in the target vehicle 10 from the ECU topological diagram, so as to determine a source of a current fault based on faulty ECU systems and a distribution of and a connection relationship among the faulty ECU systems and formulate proper maintenance and inspection orders. Therefore, the range of inspection is reduced and the working efficiency is improved.

In addition, it should be further noted that the method and apparatus for displaying a distribution and statuses of ECU systems in a vehicle may be further applied to other proper implementation environments rather than being limited to the vehicle diagnosis system shown in FIG. 1. Although FIG. 1 shows one target vehicle 10, one communication device 20, one mobile terminal 30 and one cloud server 40, those skilled in the art can understand that, the application environment may include more or fewer target vehicles 10, communication devices 20, mobile terminals 30 and cloud servers 40.

In the embodiments of the disclosure, it should be understood that the cloud server 40 generates and stores the ECU topological diagrams corresponding to various vehicle information, and the mobile terminal 30 only need to directly acquire a corresponding ECU topological diagram from the cloud server 40 when necessary. A main reason is that, in practical applications, there are diverse to-be-diagnosed vehicles and types and a distribution of ECU systems corresponding to vehicles of different types vary. Therefore, a lot of data needs to be collected to draw ECU topological diagrams for all vehicle types, which occupies relatively much storage space. In addition, drawing the ECU topological diagrams is time-consuming, which greatly reduce diagnosis efficiency. However, in some other embodiments, for example, when only a vehicle corresponding to a single piece of vehicle information needs to be diagnosed, an ECU topological diagram corresponding to the vehicle information may be drawn in the mobile terminal 30. This is not specifically limited in the disclosure.

### Embodiment 2

FIG. 3 is a schematic flowchart of a method for displaying a distribution and statuses of ECU systems of a vehicle according to an embodiment of the disclosure. The method may be performed by any type of mobile terminal (for example, the mobile terminal 10 shown in FIG. 1).

Specifically, referring to FIG. 3, the method may include but is not limited to the following steps:

Step 110: Acquire and display an ECU topological diagram corresponding to vehicle information of a target vehicle.

In this embodiment, the “target vehicle” means a to-be-diagnosed vehicle, for example, may be the target vehicle 10 shown in FIG. 1. The “vehicle information” means related information of the target vehicle, which may include but is not limited to a vehicle brand, a model, a year model, an engine type, a gearbox model, and the like used to match the ECU topological diagram applicable to the target vehicle. The “ECU topological diagram” means a graphic file used for presenting a plurality of ECU systems and a distribution of and a connection relationship among the plurality of ECU systems. For example, the ECU topological diagram may be specifically a scalable vector graphics (SVG) file carrying distribution data of ECU systems in the target vehicle. The ECU topological diagram includes at least two label elements and a topological relationship among the at least two label elements. Each of the at least two label elements is used for identifying an ECU system matching the vehicle information (that is, an ID of each of the label elements corresponds to an ID of an ECU system corresponding thereto). The topological relationship includes a connection relationship among the ECU systems.

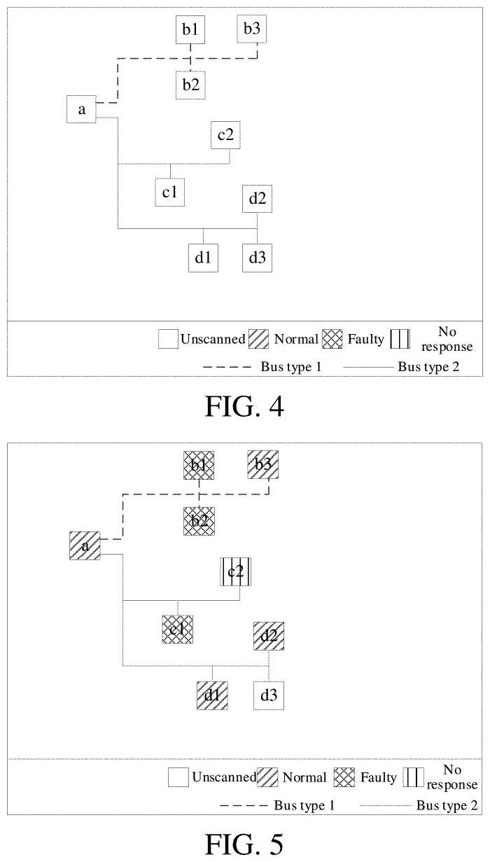

For example, FIG. 4 is an exemplary diagram of an ECU topological diagram according to an embodiment of the disclosure. In FIG. 4, a label element a is used for identifying an ECU system A, a label element b1 is used for identifying an ECU system B1, a label element b2 is used for identifying an ECU system B2. A label element b3 is used for identifying an ECU system B3. A label element c1 is used for identifying an ECU system C1. A label element c2 is used for identifying an ECU system C2, a label element d1 is used for identifying an ECU system D1. A label element d2 is used for identifying an ECU system D2 and a label element d3 is used for identifying an ECU system D3. A topological relationship among the label elements a, b1, b2, b3, c1, c2, d1, d2 and d3 is used for identifying a distribution of and a connection relationship among the ECU systems A, B1, B2, B3, C1, C2, D1, D2 and D3. The ECU systems A, B1, B2, B3, C1, C2, D1, D2 and D3 are all ECU systems matching the vehicle information of the target vehicle (or in other words, the vehicle having the vehicle information includes a part or all of the ECU systems A, B1, B2, B3, C1, C2, D1, D2 and D3).

In particular, in order to help maintenance and repair technicians learn the communication mode among the ECU systems and then determine whether the ECU systems affect each other, the connection relationship among the ECU systems includes a bus type of a connection bus among the ECU systems. For example, as shown in FIG. 4, the label element a, the label element b1, the label element b2 and the label element b3 are connected by dashed lines (where the dashed lines are used for identifying a bus type 1), which indicates that the ECU system A, the ECU system B1, the ECU system B2 and the ECU system B3 are connected by using a bus type 1.

Specifically, during diagnosis for the target vehicle, the mobile terminal may acquire the ECU topological diagram corresponding to the vehicle information of the target vehicle from a cloud server storing ECU topological diagrams corresponding to vehicle information of various types, and display the ECU topological diagram.

Alternatively, in other implementations, the mobile terminal may draw the ECU topological diagram corresponding to the target vehicle by using queried types and quantity of the ECU systems included in the target vehicle and relationship data about the ECU systems and display the ECU topological diagram.

In some embodiments, in order to help a user directly interact with the ECU topological diagram, the ECU topological diagram may be specifically an SVG file, and a Webview control may be configured in the mobile terminal. When the mobile terminal acquires related data of the ECU topological diagram, the mobile terminal may load and display the ECU topological diagram by using the Webview control.

Step 120: Acquire status information of the ECU system matching the vehicle information in the target vehicle.

In this embodiment, the “status information” means operating statuses of the ECU systems corresponding to the label elements in the ECU topological diagram in the target vehicle. The status information may include but is not limited to normal, faulty, no response, and the like. The status information “normal” means that the ECU system is operating normally in the target vehicle and no fault code exists. The status information “faulty” means that the ECU system is operating abnormally in the target vehicle and one or more fault codes exist. The status information “no response” means that the status information of the ECU system cannot be found in the target vehicle, that is, the ECU system does not exist in the target vehicle.

In practical applications, the process of acquiring the status information of the ECU system matching the vehicle information in the target vehicle may be referred to as a “scanning process”. The “scanning process” may be implemented through “selected scanning” or “automatic scanning”.

The “selected scanning” means that a user selects one or more label elements/ECU systems for scanning. Specifically, when a selected scan instruction for the ECU topological diagram is received (the selected scan instruction being used for selecting a label element in the ECU topological diagram and indicating a scan for the ECU system identified by the selected label element), the status information of the ECU system identified by the selected label element in the target vehicle is acquired according to the selected scan instruction. For example, assuming that the ECU topological diagram is an SVG file, the label elements in the ECU topological diagram may be bound to click/tap events by using a Java script. When a user (a maintenance and repair technician) clicks/taps a specific label element in the ECU topological diagram, the mobile terminal transmits a request for reading a status of an ECU system corresponding to the label element to the target vehicle to acquire status information of the ECU system corresponding to the label element in the target vehicle.

The “automatic scanning” means that after receiving an automatic scan instruction for the ECU topological diagram (the automatic scan instruction being used for indicating a scan for the ECU system identified by each of the label elements in the ECU topological diagram), the mobile terminal acquires, according to the automatic scan instruction, the status information of the ECU system identified by each of the label elements in the target vehicle.

The automatic scan instruction may be automatically triggered when the mobile terminal establishes a communicative connection to the target vehicle or may be triggered when a one-key scan command inputted by a user (a maintenance and repair technician) is received. During the “automatic scanning”, the mobile terminal may serially scan the ECU systems corresponding to the label elements (that is, scan the ECU systems one by one) according to a preset scan order or may parallelly scan the ECU systems corresponding to the label elements (that is, scan the ECU systems simultaneously), which is not limited in the embodiments of the disclosure.

Further, in some embodiments, in order to help maintenance and repair technicians learn a current diagnosis progress of one or more ECU systems, a scan progress of the ECU system may be further determined and displayed during the acquiring the status information of the ECU system matching the vehicle information in the target vehicle.

Step 130: Set, according to the acquired status information of the ECU system in the target vehicle, a display status attribute of the label element used for identifying the ECU system.

In this embodiment, the “display status attribute” means a display attribute of the label element, which may include but is not limited to a color, a shape, a word, a visibility status and the like. For example, if the ECU topological diagram is an SVG vector diagram, a CSS attribute of a label element in the SVG vector diagram is the “display status attribute”. The display status attribute of the label element corresponds to a current status of an ECU system corresponding thereto. The “current status” may include a current scan status of the ECU system (for example, unselected, selected but not scanned, a current scan progress, the ECU system has a plurality of ECU types and one ECU type needs to be specified for diagnosis, the current ECU system makes no response to barcode reading, or the like) and an operating status of the ECU system in the target vehicle (for example, normal, faulty, no response, or the like). Therefore, the maintenance and repair technicians can learn a diagnosis progress and a diagnosis result of each ECU system in the target vehicle in real time based on the display status attribute of each label in the ECU topological diagram. It should be understood that, although in FIG. 4 and FIG. 5, the “current status” includes only unscanned, normal, faulty, and no response, it is not intended to limit the present disclosure.

In this embodiment, after status information of any ECU system in the target vehicle is acquired, a display status attribute of a label element used for identifying the ECU system may be set according to the status information. For example, as shown in FIG. 5, after status information of the ECU system A is acquired as “normal”, a display status attribute of the label element a may be correspondingly set to indicate that the ECU system A is operating normally in the target vehicle.

After operating statuses of all ECU systems are acquired, the maintenance and repair technicians may determine current faulty ECU systems and a connection relationship among the faulty ECUs by using a rendered ECU topological diagram, so as to determine a source of the faults and formulate a corresponding inspection order (for example, if ECU systems on a specific bus are all faulty and all of the ECU systems on the bus are controlled by a general ECU system, the total ECU system on the bus may be first inspected). Then the ECU systems are inspected one by one according to the inspection order to determine whether the ECU systems in the target vehicle are faulty.

In order to help the maintenance and repair technicians learn detailed information of some ECU systems, such as specific functions, detailed diagnosis data streams and the like of the ECU systems to more accurately determine an inspection order and further improve diagnosis efficiency, in some embodiments, the method may further include: receiving a query instruction for a first label element in the ECU topological diagram; and displaying, according to the query instruction, detailed status information of an ECU system identified by the first label element in the target vehicle. The “first label element” may be any label element in the ECU topological diagram.

It may be learned from the foregoing technical solutions that the embodiments of the disclosure have the following beneficial advantages: According to the method for displaying a distribution and statuses of ECU systems of a vehicle provided in the embodiments of the present disclosure, the ECU topological diagram corresponding to the vehicle information of the target vehicle is first acquired and displayed, the ECU topological diagram includes at least two label elements and a topological relationship among the at least two label elements. Each of the at least two label elements is used for identifying an ECU system matching the vehicle information and the topological relationship including a connection relationship among the ECU systems. Then the status information of the ECU system matching the vehicle information in the target vehicle is acquired. Finally the display status attribute of the label element used for identifying the ECU system is set according to the acquired status information of the ECU system in the target vehicle. In this way, a distribution and operating statuses of and a relationship among ECU systems in the target vehicle can be directly presented in real time. Maintenance and repair technicians can determine a source of a current fault based on faulty ECU systems and a distribution of and a connection relationship among the faulty ECU systems and formulate maintenance and inspection orders. Therefore, the range of inspection is reduced and the working efficiency is improved.

### Embodiment 3

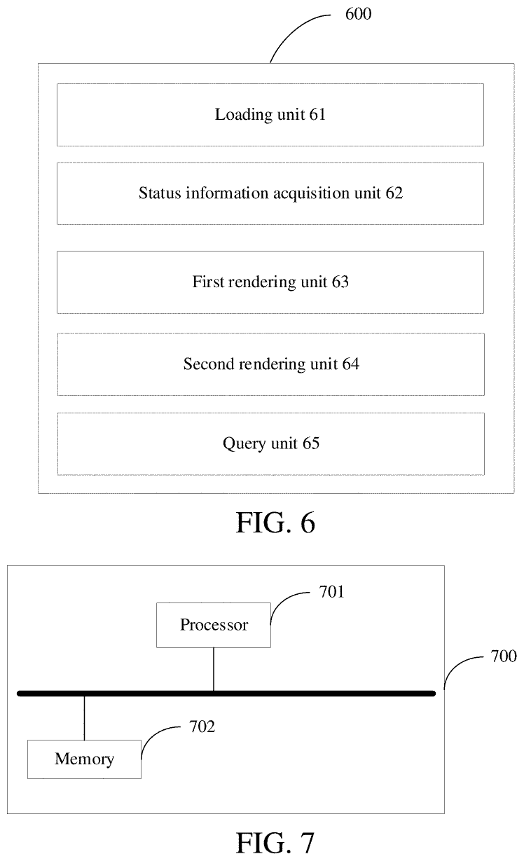

FIG. 6 is a schematic structural diagram of an apparatus for displaying a distribution and statuses of ECU systems of a vehicle according to an embodiment of the present disclosure. The apparatus 600 may run in any type of mobile terminal (for example, the mobile terminal 10 shown in FIG. 1).

Specifically, referring to FIG. 6, the apparatus 600 includes a loading unit 61, a status information acquisition unit 62 and a first rendering unit 63.

The loading unit 61 is configured to acquire and display an ECU topological diagram corresponding to vehicle information of a target vehicle The ECU topological diagram includes at least two label elements and a topological relationship among the at least two label elements. Each of the at least two label elements is used for identifying an ECU system matching the vehicle information. The topological relationship includes a connection relationship among the ECU systems. Specifically, in some embodiments, the connection relationship among the ECU systems includes a bus type of a connection bus among the ECU systems.

The status information acquisition unit 62 is configured to acquire status information of the ECU system matching the vehicle information in the target vehicle.

The first rendering unit 63 is configured to set, according to the acquired status information of the ECU system in the target vehicle, a display status attribute of the label element used for identifying the ECU system.

During diagnosis for the target vehicle, the ECU topological diagram corresponding to the vehicle information of the target vehicle may be first acquired and displayed by using the loading unit 61, and then the status information of the ECU system matching the vehicle information in the target vehicle is acquired by using the status information acquisition unit 62, and finally the display status attribute of the label element used for identifying the ECU system is set according to the acquired status information of the ECU system in the target vehicle by using the first rendering unit 63.

In some embodiments, the status information acquisition unit 62 is specifically configured to receive a selected scan instruction for the ECU topological diagram, the selected scan instruction being used for selecting a label element in the ECU topological diagram and indicating a scan for the ECU system identified by the selected label element; and acquire, according to the selected scan instruction, the status information of the ECU system identified by the selected label element in the target vehicle.

Alternatively, in some other embodiments, the status information acquisition unit 62 is specifically configured to receive an automatic scan instruction for the ECU topological diagram, the automatic scan instruction being used for indicating a scan for the ECU system identified by each of the label elements in the ECU topological diagram; and acquire, according to the automatic scan instruction, the status information of the ECU system identified by each of the label elements in the target vehicle.

In addition, in still other embodiments, the apparatus 600 further includes:

a second rendering unit 64, configured to determine and display a scan progress of the ECU system during the acquiring of the status information of the ECU system matching the vehicle information in the target vehicle.

Further, in some embodiments, the apparatus 600 further includes:

a query unit 65, configured to receive a query instruction for a first label element in the ECU topological diagram; and display, according to the query instruction, detailed status information of an ECU system identified by the first label element in the target vehicle.

It should be noted that, since the apparatus for displaying a distribution and statuses of ECU systems of a vehicle is based on the same inventive concept as the method for displaying a distribution and statuses of ECU systems of a vehicle in the foregoing embodiment, corresponding content in the foregoing method embodiment is also applicable to this apparatus embodiment. Therefore, details are not described herein again.

It may be learned from the foregoing technical solutions that the embodiments of the disclosure have the following beneficial advantages: According to the apparatus for displaying a distribution and statuses of ECU systems of a vehicle provided in the embodiments of the disclosure, the ECU topological diagram corresponding to the vehicle information of the target vehicle is first acquired and displayed by using the loading unit 61. Then the status information of the ECU system matching the vehicle information in the target vehicle is acquired by using the status information acquisition unit 62. Finally the display status attribute of the label element used for identifying the ECU system is set according to the acquired status information of the ECU system in the target vehicle by using the first rendering unit 63. In this way, a distribution and operating statuses of and a relationship among ECU systems in the target vehicle can be directly presented in real time. Maintenance and repair technicians can determine a source of a current fault based on faulty ECU systems and a distribution of and a connection relationship among the faulty ECU systems and formulate maintenance and inspection orders. Therefore, the range of inspection is reduced and the working efficiency is improved.

The foregoing described device embodiments are merely examples. The units described as separate parts may or may not be physically separate may be located in one position, or may be distributed on a plurality of network units. Some or all of the units may be selected according to actual requirements to achieve the objectives of the solutions in the embodiments.

### Embodiment 4

FIG. 7 is a schematic structural diagram of a mobile terminal according to an embodiment of the disclosure. The mobile terminal 700 may be any type of electronic device, such as a tablet computer, a smart phone, a robot, a personal computer, a wearable smart device or the like capable of performing the method for displaying a distribution and statuses of ECU systems of a vehicle provided in the foregoing method embodiment or running the apparatus for displaying a distribution and statuses of ECU systems of a vehicle provided in the foregoing apparatus embodiment.

Specifically, referring to FIG. 7, the mobile terminal 700 includes:

one or more processors 701 and a memory 702. One processor 701 is used as an example in FIG. 7.

The processor 701 and the memory 702 may be connected by using a bus or in another manner. A connection by using the bus is used as an example in FIG. 7.

As a non-transitory computer readable storage medium, the memory 702 may be configured to store non-transitory software programs, non-transitory computer executable programs and modules, such as program instructions/modules (for example, the loading unit 61, the status information acquisition unit 62, the first rendering unit 63, the second rendering unit 64 and the query unit 65 shown in FIG. 6) corresponding to the method for displaying a distribution and statuses of ECU systems of a vehicle in the embodiments of the disclosure.

The processor 701 executes various functional applications and data processing of the apparatus 600 for displaying a distribution and statuses of ECU systems of a vehicle by executing the non-transitory software programs, the instructions and the modules stored in the memory 702. That is to say, the processor 70 performs the method for displaying a distribution and statuses of ECU systems of a vehicle in any of the foregoing method embodiments.

The memory 702 may include a program storage area and a data storage area. The program storage area may store an operating system, an application program required by at least one function and the like. The data storage area may store data created according to use of the apparatus 600 for displaying a distribution and statuses of ECU systems of a vehicle or the like. In addition, the memory 702 may include a high-speed random access memory, and may further include a non-transitory memory, such as at least one magnetic disk memory device, a flash memory device, or other non-transitory solid-state memory devices. In some embodiments, the memory 702 optionally includes memories remotely disposed relative to the processor 701, and these remote memories may be connected to the processor 701 by using a network. Examples of the network include, but are not limited to, the Internet, an intranet, a local area network, a mobile communications network, and a combination thereof.

The one or more modules are stored in the memory 702, and when executed by the one or more processors 701, perform the method for displaying a distribution and statuses of ECU systems of a vehicle in any of the foregoing method embodiments. For example, the one or more modules perform the method steps 110 to 130 in FIG. 3 described above to implement the functions of the units 61 to 65 in FIG. 6.

### Embodiment 5

An embodiment of the disclosure further provides a non-transitory computer readable storage medium storing computer-executable instructions that are executed by one or more processors. For example, the computer-executable instructions are executed by the processor 701 in FIG. 7, so that the one or more processors may perform the method for displaying a distribution and statuses of ECU systems of a vehicle in any of the foregoing method embodiments. For example, the one or more processors perform the method steps 110 to 130 in FIG. 3 described above to implement the functions of the units 61 to 65 in FIG. 6.

Based on the descriptions of the foregoing implementations, those of ordinary skill in the art may clearly understand that the implementations may be implemented by software in addition to a universal hardware platform, or by hardware. Those of ordinary skill in the art may understand that all or some of procedures in the foregoing embodiment methods may be implemented by a computer program in a computer program product instructing relevant hardware. The computer program may be stored in a non-transitory computer-readable storage medium. The computer program includes program instructions. When the program instructions are executed by a mobile terminal, the mobile terminal may be caused to execute the procedures of the foregoing method embodiments. The storage medium may be a magnetic disk, an optical disc, a read-only memory (ROM), a RAM or the like.

The foregoing products (including the mobile terminal, the non-transitory computer-readable storage medium and the computer program product) can perform the method for displaying a distribution and statuses of ECU systems of a vehicle provided in the embodiments of the disclosure. The products corresponding functional modules for implementing the method for displaying a distribution and statuses of ECU systems of a vehicle and beneficial effects. For technical details that are not described in detail in this embodiment, refer to the method for displaying a distribution and statuses of ECU systems of a vehicle provided in the embodiments of the disclosure.

It should be noted that the foregoing embodiments are merely used for describing the technical solutions of the disclosure, but are not intended to limit the present invention. Under the concept of the disclosure, the technical features in the foregoing embodiments or different embodiments may be combined, the steps may be implemented in any sequence. There may be many other changes in different aspects of the disclosure as described above. For brevity, those are not provided in detail. Although the disclosure is described in detail with reference to the foregoing embodiments, those of ordinary skill in the art should understand that they may still make modifications to the technical solutions described in the foregoing embodiments or make equivalent replacements to some technical features thereof, without departing from the scope of the technical solutions of the embodiments of the disclosure.

What is claimed is:

1. A method for displaying a distribution and statuses of electronic control unit (ECU) systems of a vehicle, the method being applicable to a mobile terminal, the method comprising steps of:
acquiring an ECU topological diagram corresponding to vehicle information of a target vehicle, and displaying the ECU topological diagram to the mobile terminal, the ECU topological diagram comprising at least two label elements and a topological relationship among the at least two label elements, each of the at least two label elements being used for identifying an ECU system matching the vehicle information, and the topological relationship comprising a connection relationship among the ECU systems;
acquiring status information of the ECU system matching the vehicle information in the target vehicle; and
setting, according to the acquired status information of the ECU system in the target vehicle, a display status attribute of the label element used for identifying the ECU system.

2. The method according to claim 1, wherein the step of acquiring status information of the ECU system matching the vehicle information in the target vehicle comprises:
receiving a selected scan instruction for the ECU topological diagram, the selected scan instruction being used for selecting a label element in the ECU topological diagram and indicating a scan for the ECU system identified by the selected label element; and
acquiring, according to the selected scan instruction, the status information of the ECU system identified by the selected label element in the target vehicle.

3. The method according to claim 1, wherein the step of acquiring status information of the ECU system matching the vehicle information in the target vehicle comprises:
receiving an automatic scan instruction for the ECU topological diagram, the automatic scan instruction being used for indicating a scan for the ECU system identified by each of the label elements in the ECU topological diagram; and
acquiring, according to the automatic scan instruction, the status information of the ECU system identified by each of the label elements in the target vehicle.

4. The method according to claim 2, further comprising a step of:
determining and displaying a scan progress of the ECU system during the acquiring status information of the ECU system matching the vehicle information in the target vehicle.

5. The method according to claim 1, wherein the connection relationship among the ECU systems comprises a bus type of a connection bus among the ECU systems.

6. The method according to claim 1, wherein after the setting step, the method further comprises steps of:
receiving a query instruction for a first label element in the ECU topological diagram; and
displaying, according to the query instruction, detailed status information of an ECU system identified by the first label element in the target vehicle.

7. An apparatus for displaying a distribution and statuses of ECU systems of a vehicle, the apparatus being installed in a mobile terminal and comprising:
a loading unit, configured to acquire an ECU topological diagram corresponding to vehicle information of a target vehicle, and display ECU topological diagram on the mobile terminal, the ECU topological diagram comprising at least two label elements and a topological relationship among the at least two label elements, each of the at least two label elements being used for identifying an ECU system matching the vehicle information, and the topological relationship comprising a connection relationship among the ECU systems;
a status information acquisition unit, configured to acquire status information of the ECU system matching the vehicle information in the target vehicle; and
a first rendering unit, configured to set, according to the acquired status information of the ECU system in the target vehicle, a display status attribute of the label element used for identifying the ECU system.

8. The apparatus according to claim 7, wherein the status information acquisition unit is configured to:
receive a selected scan instruction for the ECU topological diagram, the selected scan instruction being used for selecting a label element in the ECU topological diagram and indicating a scan for the ECU system identified by the selected label element; and
acquire, according to the selected scan instruction, the status information of the ECU system identified by the selected label element in the target vehicle.

9. The apparatus according to claim 7, wherein the status information acquisition unit is specifically configured to:
receive an automatic scan instruction for the ECU topological diagram, the automatic scan instruction being used for indicating a scan for the ECU system identified by each of the label elements in the ECU topological diagram; and
acquire, according to the automatic scan instruction, the status information of the ECU system identified by each of the label elements in the target vehicle.

10. The apparatus according to claim 8, further comprising:
a second rendering unit, configured to determine and display a scan progress of the ECU system during the acquiring of the status information of the ECU system matching the vehicle information in the target vehicle.

11. The apparatus according to claim 7, wherein the connection relationship among the ECU systems comprises a bus type of a connection bus among the ECU systems.

12. The apparatus according to claim 7, further comprising a query unit configured to:
receive a query instruction for a first label element in the ECU topological diagram; and
display, according to the query instruction, detailed status information of an ECU system identified by the first label element in the target vehicle.

13. A mobile terminal, comprising:
at least one processor; and
a memory communicatively connected to the at least one processor, the memory storing instructions executable by the at least one processor, the instructions, when executed by the at least one processor, causing the at least one processor to perform a method for displaying a distribution and statuses of electronic control unit (ECU) systems of a vehicle, the method comprising steps of:
acquiring an ECU topological diagram corresponding to vehicle information of a target vehicle, and displaying the ECU topological diagram to the mobile terminal, the ECU topological diagram comprising at least two label elements and a topological relationship among the at least two label elements, each of the at least two label elements being used for identifying an ECU system matching the vehicle information, and the topological relationship comprising a connection relationship among the ECU systems;
acquiring status information of the ECU system matching the vehicle information in the target vehicle; and
setting, according to the acquired status information of the ECU system in the target vehicle, a display status attribute of the label element used for identifying the ECU system.

14. The mobile terminal according to claim 13, wherein the step of acquiring status information of the ECU system matching the vehicle information in the target vehicle comprises:
receiving a selected scan instruction for the ECU topological diagram, the selected scan instruction being used for selecting a label element in the ECU topological diagram and indicating a scan for the ECU system identified by the selected label element; and
acquiring, according to the selected scan instruction, the status information of the ECU system identified by the selected label element in the target vehicle.

15. The mobile terminal according to claim 13, wherein the step of acquiring status information of the ECU system matching the vehicle information in the target vehicle comprises:
receiving an automatic scan instruction for the ECU topological diagram, the automatic scan instruction being used for indicating a scan for the ECU system identified by each of the label elements in the ECU topological diagram; and
acquiring, according to the automatic scan instruction, the status information of the ECU system identified by each of the label elements in the target vehicle.

16. The mobile terminal according to claim 15, wherein the method further comprises a step of:
determining and displaying a scan progress of the ECU system during the acquiring status information of the ECU system matching the vehicle information in the target vehicle.

17. The mobile terminal according to claim 13, wherein the connection relationship among the ECU systems comprises a bus type of a connection bus among the ECU systems.

18. The mobile terminal according to any of claim 13, wherein after the setting step, the method further comprises steps of:
receiving a query instruction for a first label element in the ECU topological diagram; and
displaying, according to the query instruction, detailed status information of an ECU system identified by the first label element in the target vehicle.

19. The method according to claim 3, further comprising a step of:
determining and displaying a scan progress of the ECU system during the acquiring status information of the ECU system matching the vehicle information in the target vehicle.

20. The method according to claim 19, wherein after the setting step, the method further comprises steps of:
receiving a query instruction for a first label element in the ECU topological diagram; and
displaying, according to the query instruction, detailed status information of an ECU system identified by the first label element in the target vehicle.
